(19) United States
(12) Patent Application Publication
(10) Pub. No.: US 2009/0314703 A1
(43) Pub. Date: Dec. 24, 2009

(54) System and Method for Demonstrating Water Filtration and Purification Techniques

(76) Inventors: Kelsey E. Beach, Latham, NY (US); Paul M. Boyle, Houston, TX (US); Clint C. Corcoran, Houston, TX (US); Ali N. Hamshari, Pampa, TX (US); James J. Tuttle, Midland, TX (US); Brent C. Houchens, Houston, TX (US); David M. McStravick, Houston, TX (US)

Correspondence Address: 24IP LAW GROUP USA, PLLC, 12 E. LAKE DRIVE, ANNAPOLIS, MD, 21403, US

(21) Appl. No.: 12/143,709

(22) Filed: Jun. 20, 2008

(51) Int. Cl. B01D 29/56

(52) U.S. Cl. 210/232; 210/259; 210/266; 210/314; 210/335

(57) ABSTRACT

The present invention is a portable water filtration/purification system that may be used for educational purposes. It includes a plurality of stackable filtration/purification housings, each of which accommodates a different type of water filtration/purification subsystem. A pressurization cap connectable to each housing provides for pressurizing one, several or all housings stacked in a particular combination or sub-combination. The housings may be color-coded for easy identification of each the type of filter within a particular housing. The water filters or purifiers in the various housing may include, but are not limited to, a sediment filter, a carbon filter, a reverse osmosis filter, a forward osmosis filter, a chemical purifier (or purification sub-system), and/or an ultraviolet light water purifier (or purification sub-system).

### CROSS-REFERENCE TO RELATED APPLICATIONS

None.

### STATEMENT REGARDING FEDERALLY SPONSORED RESEARCH OR DEVELOPMENT

None.

### BACKGROUND OF THE INVENTION

1. Field Of The Invention

The present invention relates generally to portable systems and methods for demonstrating water filtration and purification techniques.

2. Brief Description Of The Related Art

A variety of water filtration/purification systems are available on the market today. One of the leading manufacturers of personal water filtration systems is Brita. Brita filters have a three-stage purification scheme. The first step is a sieve, which is a smaller version of a sediment filter. The water then passes through a carbon granule filter to remove chemicals like chlorine. Finally, the water passes through an ion-exchange membrane (usually made of zeolite) to remove heavy metals, such as lead, copper, or mercury.

Brita's three types of products are water pitchers, faucet filters, and refrigerator filters. These systems are primarily designed to improve the taste of water, not to remove bacteria and viruses, and they vary in effectiveness and longevity. The pitchers remove 98% of lead, 88% of copper, and 91% of mercury. The lifespan of the pitcher is 40 gallons before the filter must be replaced. The Brita faucet filters additionally remove 99.99% of microbiological cysts like cryptosporidium and giardia (3-4 microns), but do not remove bacteria or viruses. These faucet filters last for 100 gallons before needing replacement. The refrigerator filters have a potentially longer life, but it is recommended to change them every six months for maximum performance.

The Culligan Company provides a point-of-use device the size of a vending machine that distributes large quantities of water. These commercial filters remove more contaminants from water than the personal-size Brita filters. In addition to using sediment and activated carbon filters, the Culligan water machines also implement reverse osmosis and ultraviolet (UV) light processes. Even though these machines are used on pretreated water coming from municipal water lines, these systems are still able to remove 99.99% of potential dangers. The Culligan water machines require indoor plumbing and an electrical power outlet in order to function.

The LifeStraw is a handheld, personal filter through which users suck water as they would a normal straw. Unlike the previous two technologies, the main purpose of the LifeStraw is the eradication of disease such as typhoid, cholera, dysentery, and diarrhea. It requires no electricity or replacement parts. This simple, lightweight device uses a three-stage purification method. First, water passes through a textile pre-filter to eliminate any particles or debris larger than 15 microns. Then activated carbon removes any chemicals or large parasites. Finally, the device kills bacteria with a halogen-based resin.

There are some disadvantages to the LifeStraw product. It has a limited lifespan of 185 gallons, which equates to about a year of use with 2 liters per day. This water is suitable for drinking purposes only, not for cooking, bathing, or agriculture. The amount of water purified is also relatively small. It does not remove heavy metals such as lead, copper, or mercury. One advantage, though, is a very low cost of $3.50 per unit.

The final current technology considered in this report is a portable UV germicidal bulb called the SteriPen. The SteriPen emanates ultraviolet light that breaks down the proteins, DNA or RNA found in bacteria and viruses. By simply stirring the device in a bottle of water, the SteriPen kills 99.9999% of bacteria and eliminates 99.99% of viruses, according to studies conducted at the three universities (University of Maine, University of Arizona, and Oregon Health Sciences University). This purification process transpires relatively quickly, taking 38-48 seconds to sanitize 16 ounces and about 90 seconds for a full 32 ounces.

In addition to being fast and effective, the SteriPen is also lightweight and durable. Only eight ounces in weight, this device is light enough even for a child to use. With a thick quartz sleeve protecting the UV bulb, bulb replacement is not a significant concern. The device is resistant not only to physical damage but also to fatigue. The bulb's longevity is around 5000 purification doses, which would provide approximately three doses per day for 4.5 years.

Though the SteriPen seems to have many advantages, it also comes with some disadvantages. The device requires four disposable or externally rechargeable AA batteries, which can be a problem if the user is away from reliable power or in a developing country. Also, the SteriPen is not a standalone method but requires some sort of mechanical pre-filter to remove sediment. Finally, the most prohibitive factor is the SteriPen's high cost. The tool costs between 79 and 99 USD.

Over one billion people worldwide do not have access to a safe, reliable source of drinking water. Of these one billion people up to five million will die each year of waterborne diseases due to unclean water sources and poor sanitation and hygiene. There is and has been a need for systems and methods for educating people about the dangers of contaminated drinking water and how to remove these contaminants from water.

### SUMMARY OF THE INVENTION

In a preferred embodiment, the present invention is a portable water filtration/purification system that may be used for educational purposes. The system comprises a plurality of filtration/purification housings. A different type of water filtration/purification subsystem is located within each housing. The housings are removably connectable to one another in a stacking manner such that the housings may be stacked in any sequence and in any combination or sub-combination. The system may further comprise a pressurization cap connectable to each housings to provide for pressurizing one, several or all housings stacked in a particular combination or sub-combination. The housings may be color-coded or marked in some other way to provide easy identification of each the type of filter within a particular housing. In one embodiment, one or more of the housings are comprised of PVC pipe and threaded PVC fittings.

Within each housing is a particular type of water filter or water purifier. The water filters or purifiers in the various housings may include, but are not limited to, a sediment filter, a carbon filter, a reverse osmosis filter, a forward osmosis filter, a chemical purifier (or purification sub-system), and/or an ultraviolet light water purifier (or purification sub-system).

In another embodiment, the present invention is a portable educational water filtration/purification system. The system comprises a sediment water filter within a first housing, a carbon water filter within a second housing, a reverse osmosis water filter within a third housing, a forward osmosis water filter within a fourth housing, a chemical water purifier within a fifth housing, and an ultraviolet light water purifier within a sixth housing. Each of said first, second, third, fourth, fifth and sixth housings comprises means for removably stacking the housing with each other housing in a substantially water-tight manner. Any combination of the first, second, third, and any one of the fifth or sixth housings can be connected in any sequence and/or in any sub-combination. The fourth housing, containing the forward osmosis filter, is stand alone in operation. The water can be poured from the fourth, fifth or sixth housing into any other housing, or combinations thereof. The means for removably stacking the housings may comprise threads, grooves and ridges, gaskets, or any other known structures for removably connecting two housings together in a stackable and substantially water-tight manner. The portable educational water filtration/purification system may further comprise a pressurization cap or other known means for pressurizing one or more of a plurality of housings that are stacked together. Still further, the portable educational water filtration/purification system may have a receptacle for receiving filtered/purified water. The receptacle may comprise means for stacking with any of the first, second, or third housings. The fourth, fifth and sixth housings contain built-in receptacles.

Still other aspects, features, and advantages of the present invention are readily apparent from the following detailed description, simply by illustrating preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a diagram of a plurality of stackable water filtration/purification housings stacked together in accordance with a preferred embodiment of the present invention.

FIG. 2(a) is a perspective view of a sediment filter housing in accordance with a preferred embodiment of the present invention.

FIG. 2(b) is a top view of a sediment filter housing in accordance with a preferred embodiment of the present invention.

FIG. 2(c) is a bottom view of a sediment filter housing in accordance with a preferred embodiment of the present invention.

FIG. 2(d) is a side view of a sediment filter housing in accordance with a preferred embodiment of the present invention.

FIG. 2(e) is a cross-section of a sediment filter and housing in accordance with a preferred embodiment of the present invention.

FIG. 3(a) is a perspective view of a carbon filter housing in accordance with a preferred embodiment of the present invention.

FIG. 3(b) is a top view of a carbon filter housing in accordance with a preferred embodiment of the present invention.

FIG. 3(c) is a bottom view of a carbon filter housing in accordance with a preferred embodiment of the present invention.

FIG. 3(d) is a side view of a carbon filter housing in accordance with a preferred embodiment of the present invention.

FIG. 3(e) is a cross-section of a carbon filter and housing in accordance with a preferred embodiment of the present invention.

FIG. 4(a) is a side view of a reverse osmosis filter and housing in accordance with a preferred embodiment of the present invention.

FIG. 4(b) is a cross-section of a reverse osmosis filter and housing in accordance with a preferred embodiment of the present invention.

FIG. 5(a) is a side view of an ultraviolet purifier and housing in accordance with a preferred embodiment of the present invention.

FIG. 5(b) is a bottom view of an ultraviolet purifier and housing in accordance with a preferred embodiment of the present invention.

FIG. 5(c) is a top view of an ultraviolet purifier and housing in accordance with a preferred embodiment of the present invention.

FIG. 5(d) is a second side view of an ultraviolet purifier and housing in accordance with a preferred embodiment of the present invention.

FIG. 6 is a cross-sectional view of a forward osmosis filter housing in accordance with a preferred embodiment of the present invention.

FIG. 7 is a side view of a chemical purifier housing in accordance with a preferred embodiment of the present invention.

### DETAILED DESCRIPTION OF THE PREFERRED EMBODIMENTS

In a preferred embodiment of the present invention, water treatment occurs in stages, with each stage consisting of a different water filter or purifier inside its own housing. These water filtration/purification housings create a watertight environment that can be pressurized and that allow water to be easily poured in and let out.

The water filtration/purification methods or sub-systems discussed herein reflect commonly encountered health threats, but the present invention is not limited to these specific methods and/or subsystems, but rather, one of skill in the art will understand that the present invention may be used with other water filtration methods and subsystems as well. In a preferred embodiment of the invention, large contaminants like dirt are handled by carbon and sediment filters. Chemical contaminants, such as chlorine and some metals are also removed by the carbon filter. Forward and/or reverse osmosis membranes remove most chemical contaminants, and bacteria and viruses. Reverse osmosis membranes also effectively remove salts. Biological contaminants, namely bacteria and viruses, can also be disinfected by chemical treatment and ultraviolet light. Water can be tested with a testing kit before and after the water is purified using various arrangements of the water filtration/purification housings. This testing enables the students to see how water quality can improve when multiple purification methods are used in tandem.

Each filtration/purification stage or housing may be carried, for example, in a student backpack. Other arrangements for transporting the systems may be used with the present invention. Once on site, students may combine the housings according to the laboratory procedures. The testing supplies may, for example, be carried by a teacher or instructor who can explain the water-purification processes as they occur and during testing.

Having multiple filters is important both to ensure the highest quality of water and to educate the user on the purpose and effectiveness of each method. The ability to connect the filters/purifiers in series will show students how they may be used together to achieve superior results and how the order affects the quality of the final product.

In a preferred embodiment, the various stackable housings are made from PVC pipe and acrylic, which are inexpensive and versatile. The housings screw together, thereby creating a large number of possible laboratories. This concept also allows for the filtration/purification methods to be easily split up among multiple backpacks and promotes collaboration between students by requiring several housings in each experimental assembly.

In a preferred embodiment, a series of experiments are performed with water being tested at the beginning and end of each experiment. Other embodiments are possible, however, in which valves are placed between each purification method in the complete assembly thereby permitting students to extract test samples after water has passed through each housing in the laboratory.

In the preferred embodiment, multiple methods (or housings), not just the reverse osmosis, are pressurized in order to provide an acceptable flow rate. To provide pressurization, a pressurizing cap is added to the top of the system. This cap forces water through not only the reverse osmosis membrane, but the sediment and carbon filters as well.

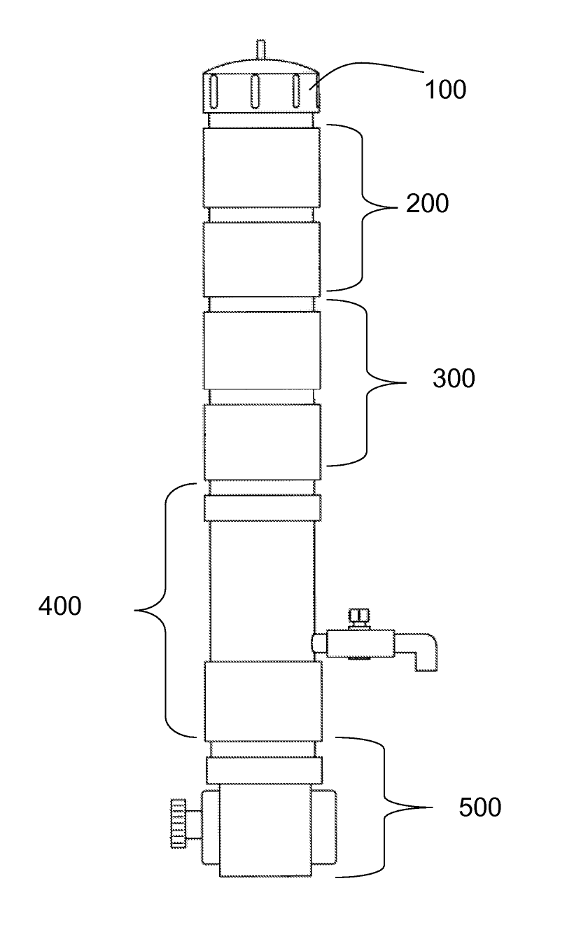

An example of several water filtration/purification housings stacked together is shown in FIG. 1. A pressurization cap 100 is located at the top of stack. A sediment filter 200 is located just below and connected to the pressurization cap 100. A carbon filter 300 is connected to and adjacent the sediment filter 200. A reverse osmosis filter 400 and an ultraviolet purifier 500 are located below the carbon filter 300. As discussed below, other types of filters or purifiers may be added to the stack or may replace these particular filters in the stack.

As water passes through the stack of filters it needs to collect in a final location. A simple outlet cup, for example, composed of an acrylic circular end-cap attached to the bottom of the tube or cylinder. A male PVC thread may be added to the top of the cylinder to attach it to the bottom of any of the filtration/purification housings. The outlet cup may be marked with volume measurement lines. Further, a hole may be made in the side of the outlet cup, for example, slightly below the male thread and above a 1.0 liter line, to alleviate air pressure that could potentially damage the system.

In a preferred embodiment, the pressure cap 100 is a simple combination of a 4″ PVC cap with a Schrader valve placed in the center. The pressure is provided by a standard bicycle tire pump, powered by foot or hand. Other types of valves and pumps may be used.

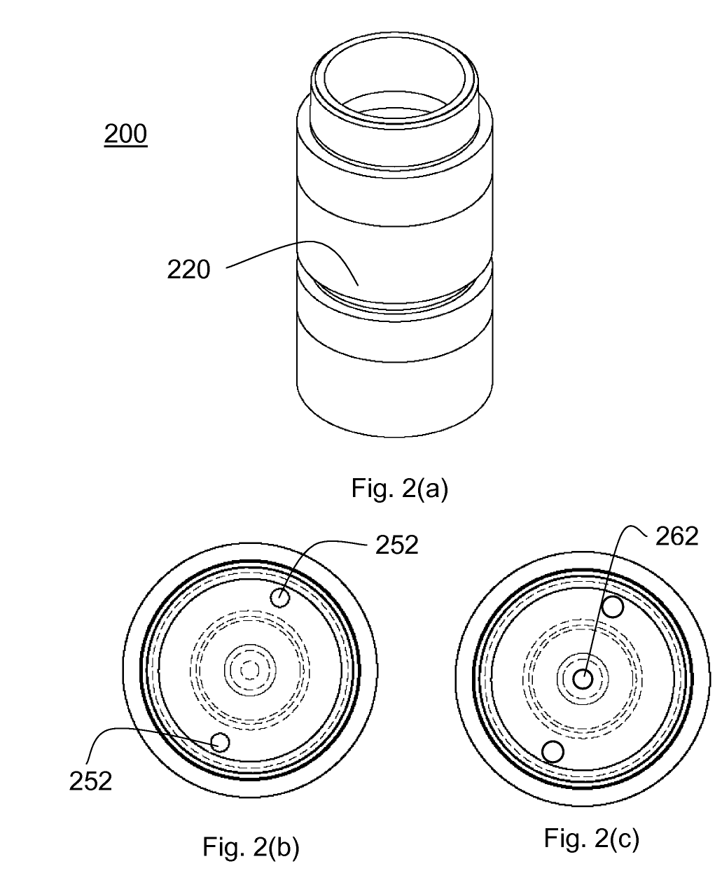

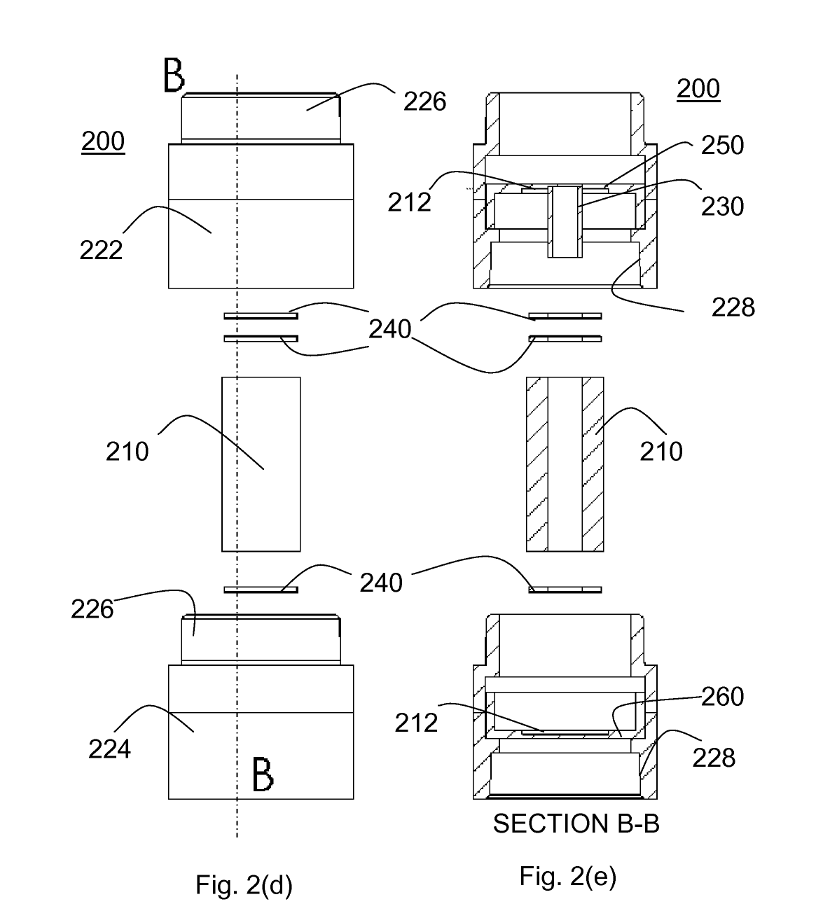

The sediment filter 200, shown in FIGS. 2(a)-(e), is a porous media filter that traps particulate matter present in water. The designation “sediment filter” refers to the substances that are filtered out, rather than the material composition of the filter.

Sediment may be defined as any suspended matter found in water, including silt, clay, colloids and many types of microorganisms. A sediment filter's ability to remove sediment from water is given by its filter rating. A nominal filter rating indicates the average pore size for filtration. In general, about 80% of particles larger than the nominal rating, usually given in microns, will not pass through the filter. When strict limitations for filtration are in place, an absolute filter rating should be used. An absolute rating is the largest pore size present in the filter media and indicates that 99.9% of particles passing through the filter will be smaller than the given rating.

In a preferred embodiment, a 5 micron nominally rated sediment filter is used. The filter is 4⅞″ long and is made from spun polypropylene. The nominal rating is sufficient for pre-filtering in the experiments. Sediment filters composed of other materials such as glass, polyester, and polyethylene are available and may be used. Polypropylene was chosen for the preferred embodiment due to its combination of price, operating temperature, breaking tenacity, and resistance to wear.

The sediment filter is the shape of a thick-walled hollow cylinder 210. Turbid water travels from the outside of the cylinder 210 to the inside through the cylinder walls. As water passes through the porous material of the walls, contaminants are trapped, allowing cleaner water to the inside of the cylinder. The filter 210 is mounted in a housing 220 formed of top 222 and bottom 224 halves. The top and bottom halves each have a threaded male portion 226 and a threaded female portion 228 to connect the halves together and to connect the sediment filter stage to other stages. Plugs 250, 260 are inserted into the top and bottom halves 222, 224 of the housing. On the inside of the plugs 250, 260 a groove 212 is machined to the outer diameter of the sediment filter to provide a proper seating for the filter. While these grooves 212 provide support for the filter, a stand pipe 230 was glued to center of the top portion of the housing, inside a shallow groove, and runs down the center of the filter for 2″, ensuring the filter remains centered in the housing. Rubber gaskets 240 are located above and below the filter. Two holes 252 are placed in the top plug 250 to allow dirty water to reach the outside of the filter. A single outlet hole 262 is placed in the bottom plug 260 to allow filtered water to pass to the next stage.

In the preferred embodiment, the system is pressurized by the pressure cap at the top of the system to increase flow through the various stages. With respect to the sediment filter, gravity may be sufficient to push water through the filter walls and out an exit hole located in the center of the bottom plug.

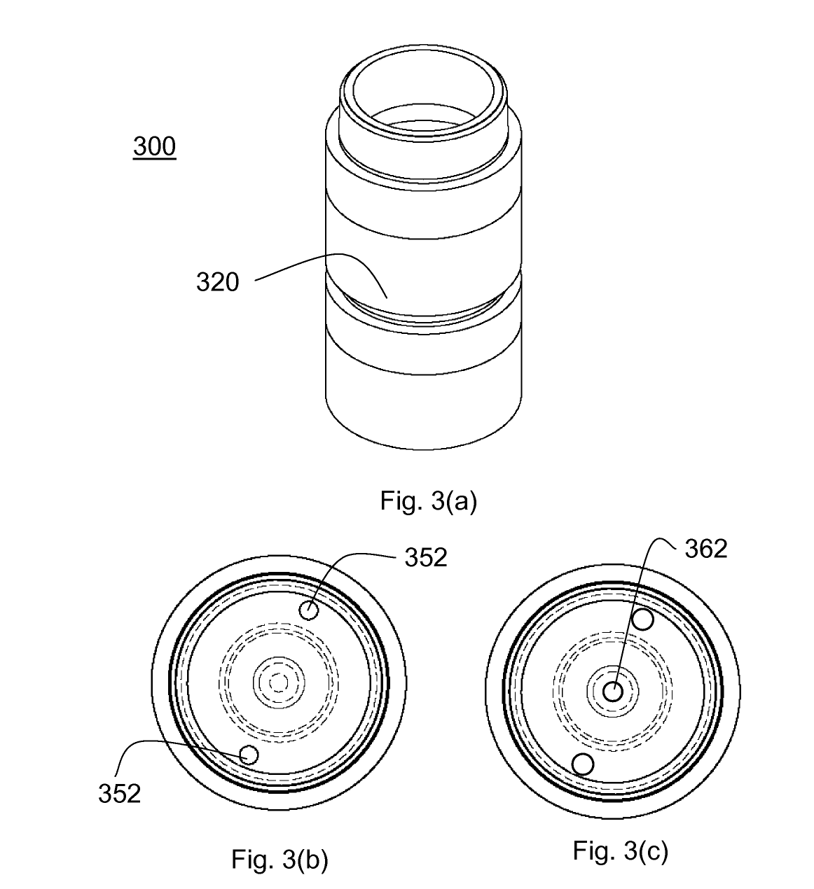

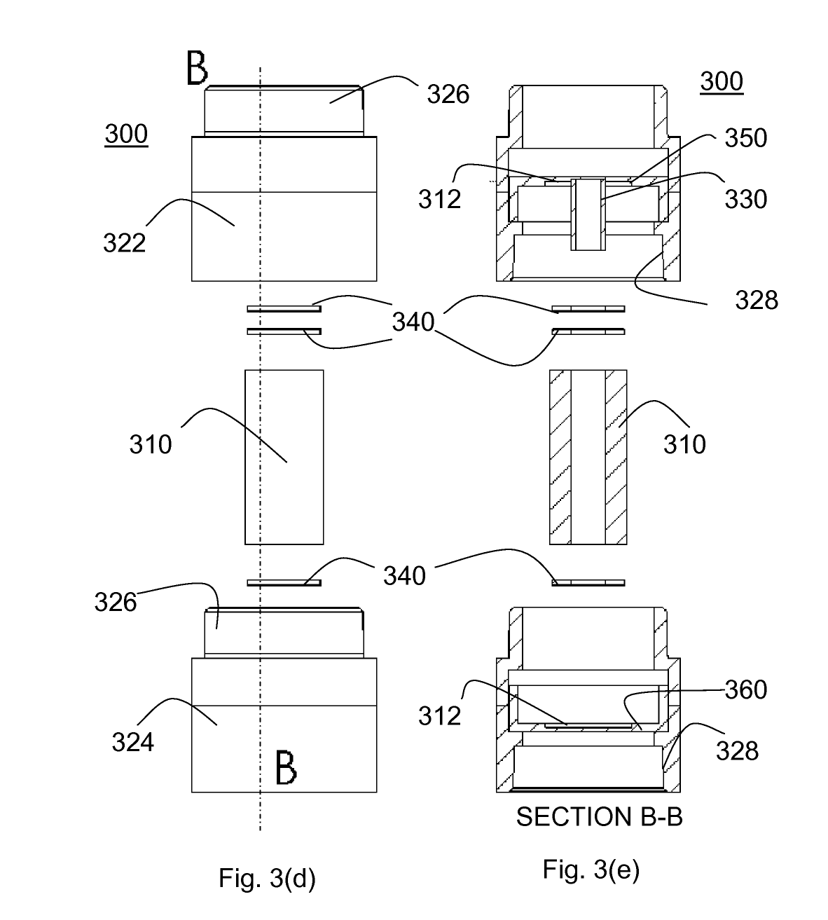

The activated carbon filter, shown in FIGS. 3(a)-(c), is a cartridge-based device that typically contains granules or a brick of raw carbon that has been “activated” by treatment with high temperature oxidizing gases. Unlike the sediment filter, the micron rating of the carbon filter is not necessarily important. The carbon filter is meant to remove chemicals and heavy metals from the solution rather than macromolecules; however, lower micron ratings are useful to supplement sediment filtration. The activated carbon filter removes chlorine, heavy metals, and organic compounds like benzene, effectively improving taste and odor in addition to potability. A carbon filter is necessary between a chemical treatment and a reverse osmosis filter, because it removes any chemicals, such as chlorine, that would destroy the reverse osmosis filter.

The carbon filter cartridge in the preferred embodiment has a block of carbon 310. The carbon block creates a large surface area over which the water runs and facilitates bonding to chemicals in solution. The carbon block was chosen over granular carbon suspended in cellulose for two reasons: the cellulose filter is susceptible to bacterial degradation, and a carbon block filter has a smaller micron rating. Planning for use in varied settings, we erred on the side of caution and used a carbon block filter. The micron rating on this cartridge is 0.5 microns (compared to the best cellulose filter at 5 microns). This micron rating means that it will act as a second sediment filter after the primary sediment filter, reducing clogging in stages further along in the system. The carbon filter has a limited life due to clogging, as with the sediment filter, or due to saturation of the activated carbon with contaminants. The preferred filter is rated for 3,000 gallons of use before requiring replacement, which should be more than sufficient for the expected use. The filter is also about 5 inches long, which will make the whole housing subassembly fairly short and minimize impact on the stability of the fully assembled system.

The carbon filter 310, shown in FIGS. 3(a)-(e), is a similar size and shape to the sediment filter, and so the housings for the two filters are very similar. Brackish water travels from the outside of the carbon block 310 to the inside. The carbon block 310 is mounted in a housing 320 formed of top 322 and bottom 324 halves. The top and bottom halves each have a threaded male portion 326 and a threaded female portion 328 to connect the halves together and to connect the sediment filter stage to other stages. Plugs 350, 360 are inserted into the top and bottom halves 322, 324 of the housing. On the inside of the plugs 350, 360 a groove 312 is machined to the outer diameter of the sediment filter to provide a proper seating for the filter. While these grooves 312 provide support for the filter, a stand pipe 330 was glued to center of the top portion of the housing, in a shallow groove, and runs down the center of the filter for 2″, ensuring the filter remains centered in the housing. Rubber gaskets 340 are located above and below the filter. Two holes 352 are placed in the top plug 350 to allow dirty water to reach the outside of the filter. A center outlet hole 362 is placed in the bottom plug 360 to allow filtered water to pass to the next stage.

The primary difference between the sediment filter housing 220 and the carbon filter housing 320 is size of the groove 312 machined into the plugs. Additionally the height of the carbon filter 310 is slightly less than that of the sediment filter, so the position of the plug in the bottom section of the carbon housing was raised slightly. The same sealing can be accomplished by adding a few gaskets in the sediment housing, allowing a sediment housing to hold a carbon filter if needed.

Filtration via reverse osmosis (RO) is commonly used in household and industrial water-treatment systems. The process uses a pressure gradient to force the solution through a semi-permeable membrane that traps the solute on one side and the solvent on the other. For purposes of the present invention, the solute is the dirty part of the water while the solvent is clean water. For the clean water to cross the membrane effectively, pressures of between 60 psi and 100 psi are typically suggested. However, the membrane used in a preferred embodiment of the present invention will actually generate permeate between 35 and 50 psi, a far lower pressure.

An RO system has to overcome osmotic pressure, which naturally drives solvent from solution of lower concentration to solution of higher concentration. The side with dirty water is highly concentrated, and therefore the pressure must be applied to drive the solution through the semi-permeable membrane to the less-concentrated side. However, the dirty particles remain trapped where they are because the membrane is semi-permeable, allowing through only clean water. The remaining dirty particles form a solution known as brine, which must be drained out of the system. The pressure gradient that separates the clean water from the concentrate or brine water needs to be higher than the given osmotic pressure, which is the inherent pressure differential as a result of solute-concentration differences.

RO membrane pore sizes vary from 0.0001 to 5 microns. Typical particle filtration employs membranes with pores of about 1 micron. Micro and nano RO filtration uses membranes as small as 0.001 microns to remove viruses from water. In a preferred embodiment of the invention, an RO membrane with pore size of 0.0009 microns is used to filter out any remaining solid particles after sediment and carbon filtration. Membranes with other pore sizes, of course, may be used with the present invention. In being conservative and to preparing for as many potential problems as reasonably possible, the small pore size in the preferred embodiment will be able to filter out most viruses and bacteria.

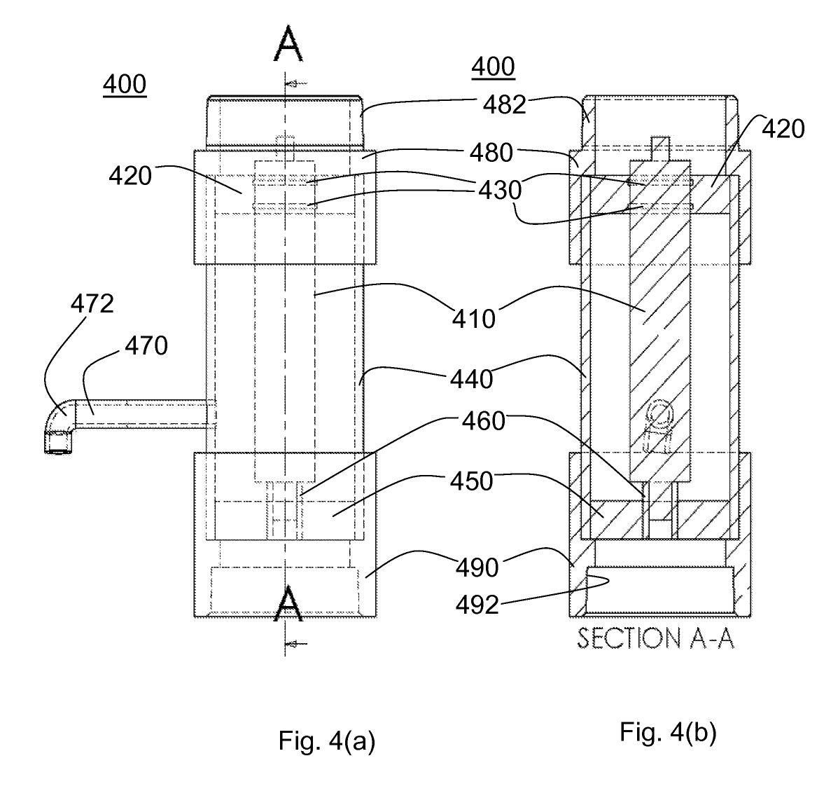

To implement an RO filtration system in the stackable design of the preferred embodiment, the base housing design was varied to allow for longitudinal pressurization. A preferred embodiment of a reverse osmosis stage in accordance with the present invention is shown in FIGS. 4(a)-(b). To apply pressure to the top of the membrane, a disk 420 of PVC bar stock machined to fit the membrane and seal with a pair of o-rings 430 inside a 9-½″ length of 4″ diameter PVC pipe 440 was used. The water then would then flow through the membrane, generating permeate and concentrate. To separate the permeate from the concentrate, a second precision machined PVC disk 450 was placed on the bottom the membrane. To permit concentrate flow out the bottom of the membrane without unseating the membrane, a smaller center pipe 460 was placed in the center of this disk 450 to raise the membrane off the disk 450 but still allow for an effective seal. A valve 470 is closed during pumping. After filtering is complete, the pressure is relieved, and the concentrate is drained. The housing further has top and bottom members 480, 490 having threads 482, 492 for stacking the housing with other housings in the system.

The RO membrane is imbedded in the cylinder 410. The RO filter is held in place by the two disks 420, 450 in the PVC pipe 440. In addition to sealing the housings, o-rings 430 at the top and bottom (not shown) provide stability for the membrane, generating a strong frictional hold on the membrane in the longitudinal axis of the pipe. The pressure relief valve 470 extends out the side of the central pipe, allowing for removal of concentrate. An elbow 472 on the end of this valve 470 directs pressurized flow toward the ground or an outlet cup and away from the user.

RO filtration systems have a finite lifetime because the membrane will clog and require replacement when flow becomes inhibited, after several thousand gallons of use. Additionally, the membrane cannot dry out, and the central pipe where permeate flows must remain sterile. Therefore, proper maintenance of the system is required. After use the housing must be sealed by closing the concentrate valve and attaching a cap and plug (not shown) to both the in and out flow ends, respectively. Storage instructions, and materials, will be provided with the system.

Ultraviolet (UV) light purification is a water-treatment technique that uses ultraviolet radiation to eliminate the dangers of mold, viruses, bacteria, and other biological agents. When these harmful organisms absorb UV light, it damages their DNA or RNA, killing them and preventing their passing on diseases. Like the chemical treatment, UV purification neutralizes contaminants and disease-causing organisms but does not remove them from the water. A wavelength between 200 and 300 nm kills microbes; wavelengths of 260-265 nm are most effective.

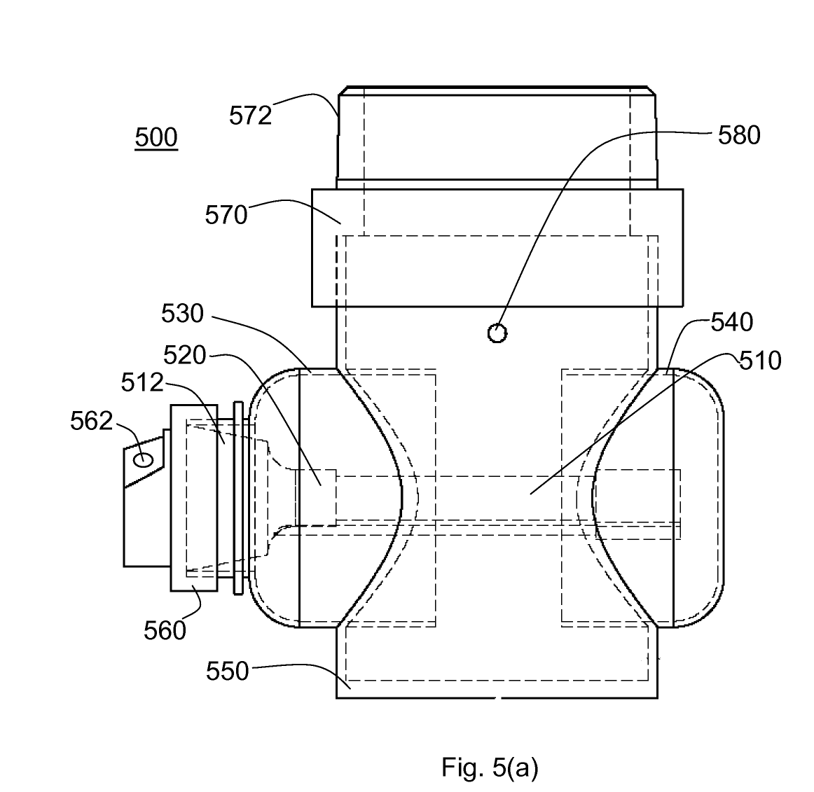

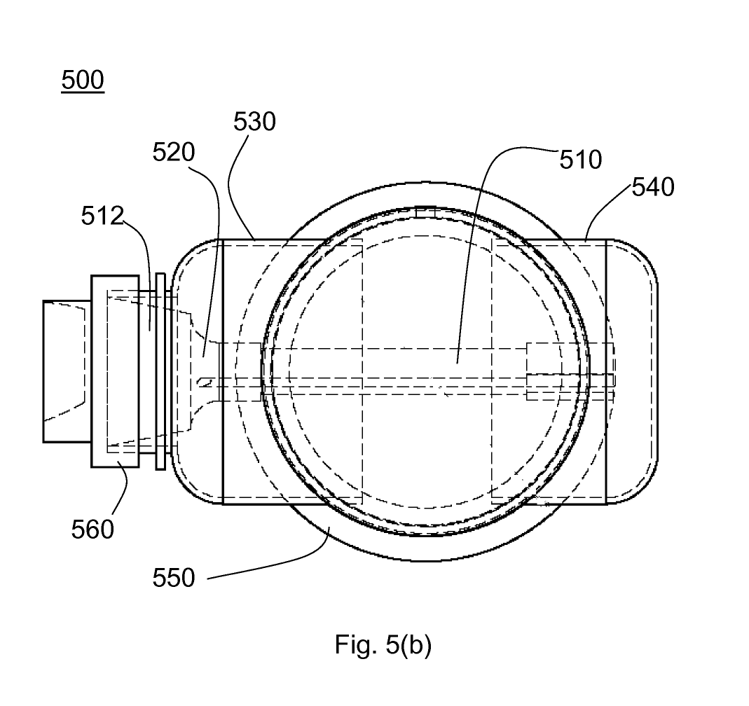

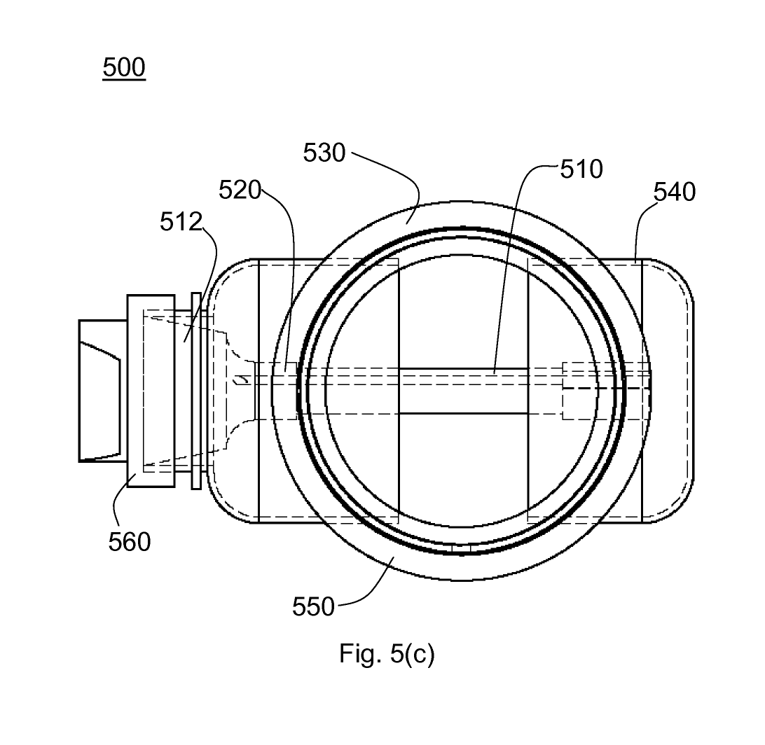

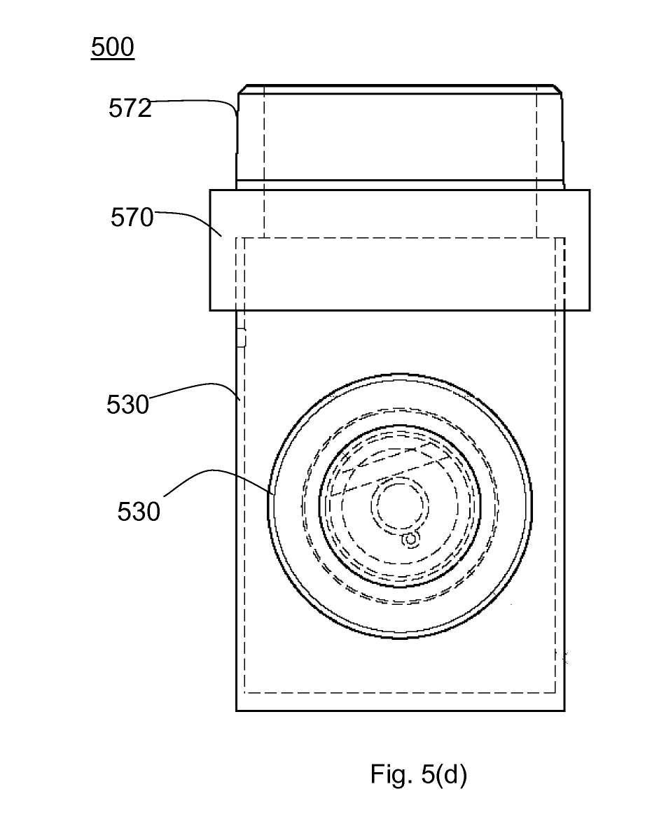

A preferred embodiment of the UV stage of the present invention, shown in FIGS. 5(a)-(d), uses the electronics from the Aquastar™ Plus! UV Water Treatment Device from Meridian Design, Inc. The UV bulb 510 screws into a socket 520 that has been adapted from the original Aquastar™ purifier container. The center section of a container was cut away, and the two resulting pieces 530, 540 were glued into walls of an outlet cup 550. The outlet cup 550 was adapted by cutting a circular hole in the side of the cylinder and another hole exactly opposite of it, generating a cross to expose the water to the UV light. The bulb 510 and battery pack 512 fit into the adapted outlet cup 550 via the threaded cap 560. The UV bulb 510 operates on two rechargeable CR123A lithium ion batteries; the batteries can be recharged with solar powered backpacks.

The container 550 should be filled to the 1-liter level and the top covered, either by another filter housing via top member 570 with threads 572 or a lid (not shown) to protect the eyes. The UV bulb is then activated via a button 562 on the electronic pack outside of the modified outlet cup 550. The outlet cup includes a pressure relief hole 580. The bulb runs for 80 seconds and shuts off automatically. In order to ensure that all contaminants have been removed, experimental directions will advise a double dose for a total of 160 seconds. Since the UV housing can be filled up to 1.3 L, this double dose ensures maximum safety. The automatic shutoff conserves battery life, reduces the possibility of user error, and prevents accidental exposure to the light.

Slight agitation is recommended to ensure that all of the water is evenly exposed to the UV light. To agitate the water the lid will be placed on the system and then the container can be lightly shaken.

UV light can degrade plastic over time. After researching the possibilities of protective coatings and the amount of light necessary to degrade plastic, we determined that the strength of the bulb was not sufficient to reach the acrylic in the housing with sufficient intensity or for a long enough period of time to merit any additional protective measures for the housing.

The National Sanitation Foundation (NSF) has established two classifications for ultraviolet systems. Each classification requires a different dose, which is defined as the product of UV light intensity and exposure time. Class A systems disinfect or remove microorganisms to a safe level and require a UV dose of 40 mJ/cm² or 40,000 μJ/cm². Class B systems are designed for supplemental bacterial treatments and require a UV dose of 16 mJ/cm² or 16,000 μJ/cm². The device of a preferred embodiment is designed to be a Class A system. By this classification, a UV dose of 40 mJ/cm² or 258 mJ/in² is necessary for safe drinking water. The device of the preferred embodiment achieves this dosage.

There are many advantages to UV water purification systems. UV does not alter the taste, odor, color, or pH of the water. It does not create toxic by-products, unlike some chemical treatments. UV systems are generally compact, easy to use, and easy to maintain.

There are some problems associated with UV purification. First, the water must be relatively clear before using UV purification. Suspended solids should be less than 10 mg/L, and turbidity levels should be less than 5 NTU. The present invention can be used for experiments designed experiments to demonstrate this requirement. In one experiment, students use only the UV housing and lid. In another experiment, the UV treatment is preceded by the sediment and carbon filtration. The students can test to see the contrast between the two experiments and note that not all contaminants are neutralized when the UV treatment is used by itself.

UV light is also harmful to the eyes and skin. Fortunately, most common materials, such as plastic or glass, block the harmful UVC rays. Even the air-water interface deflects the UVC rays, so the system would be safe to observe as long as the fluorescent bulb is completely submerged. Extensive warnings will be provided in the instruction materials and potentially on the lid itself to prevent injury.

In another embodiment of the present invention a failsafe mechanism such that students cannot activate the UV system unless the bulb is properly installed in the housing. In the preferred embodiment described above, the bulb never has to be removed from the system except for replacement, so the risk of a student accidentally turning the UV bulb on outside the container is slim. The next most likely point of exposure would be through the top of the container. This issue has been addressed by covering the container with a cap (when not stacked with other housings) and including extensive warning information. However, additional measures could be taken.

Osmosis is the process through which water, acting as a solvent, is drawn from out of a dilute solution and into a more concentrated solution. Water moves in order to achieve equilibrium between solute and solvent on either side of a permeable membrane. All that is needed for osmosis is a concentration gradient across a membrane. In the forward osmosis (FO) method of water purification, water crosses a membrane of extremely small pore size. In contrast to RO, water is pulled rather than pushed across the membrane. FO requires no fuels, pumps or moving parts: it is powered solely by the existence of a concentration gradient. In the preferred embodiment, the forward osmosis stage has been set up as a stand-alone operation, but other arrangements are possible.

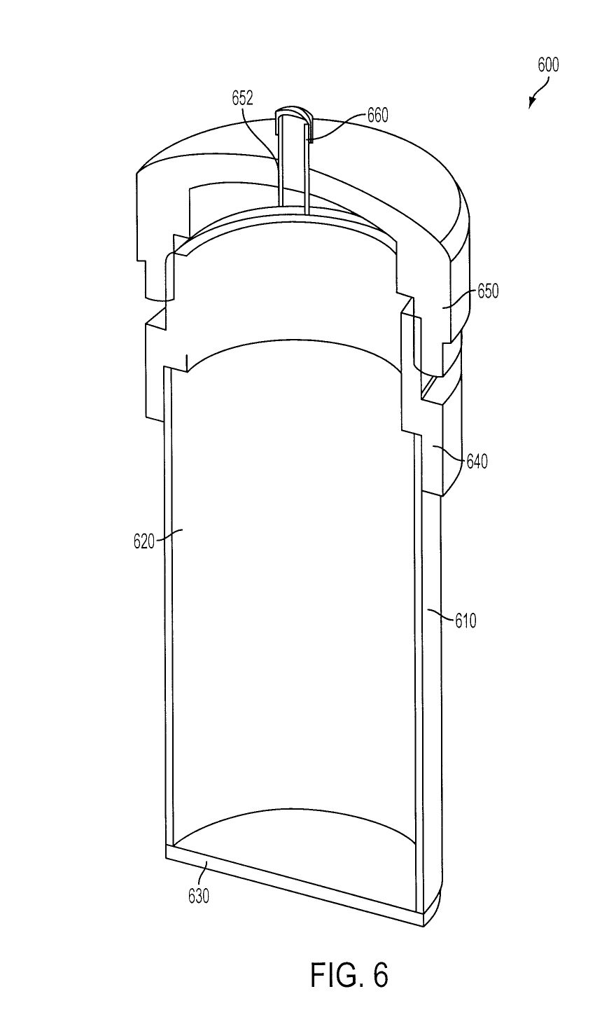

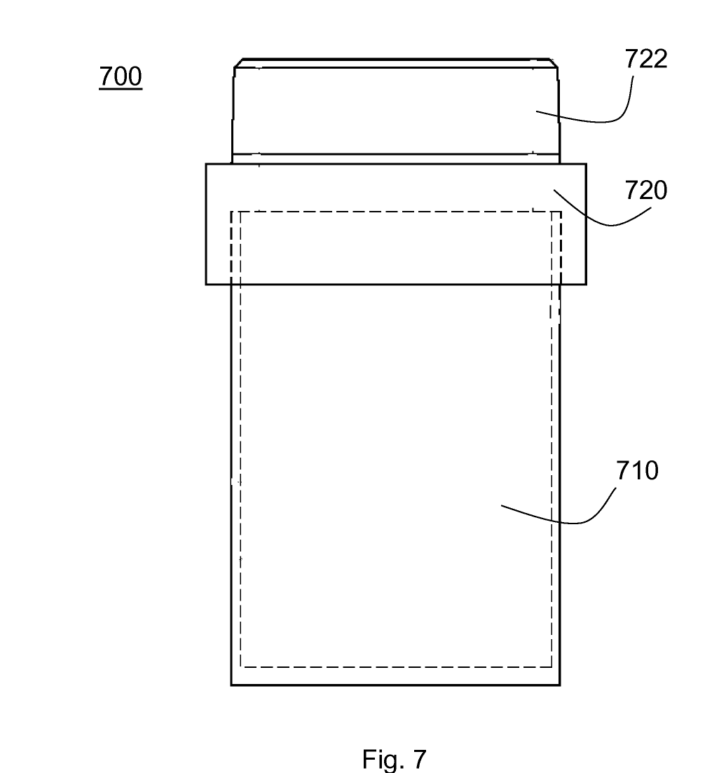

The FO design of the preferred embodiment is shown in FIG. 6. The housing 610 of the FO stage in a preferred embodiment of the present invention is an 8¾″ section of clear acrylic piping. The length is dictated by the length of the osmosis membrane, which fits inside the housing 620. A 4¼″ diameter base 630 was cut out from clear acrylic and attached to the bottom of the section 610. A male thread PVC adapter 640 is glued with PVC primer and cement to the top of the section 610. A ½″ hole 652 is drilled in the center of a female threaded cap 650. An exit spout 660 for the forward osmosis membrane was passed upwards through the cap, holding the membrane in place.

To operate the FO, the clear acrylic section of the housing is filled with contaminated water. The osmosis membrane, which is attached to the cap, is then dropped into the contaminated water and screwed in place. A charge of syrup is poured into the membrane's outlet tube, and four hours later the membrane is filled with purified water.

The forward osmosis stage of the present invention has several advantages over some prior forward osmosis filters. An advantage of the present invention is that the portion of the membrane in contact with contaminated water can be easily cleaned. The membrane is also offered added protection from puncturing or other damage. Drying of the membrane remains a problem, though with proper maintenance and care prior forward osmosis filters have lasted beyond their expected 10 day use.

The chemical treatment stage 700 uses chlorine dioxide tablets to disinfect the water. One tablet of chlorine dioxide is applied to one liter of water. The chemical tablet is added through the open top of the outlet cup 710. A lid 100 may be placed on the top of the outlet cup 710 via the attached male fitting 720. The cup may have a threaded portion 722 for connection to the other stages and an opening (not shown) to permit relief of pressure. Since the chemical treatment takes up to four hours to eliminate threats such as cryptosporidium parvum, the container can be set aside while other experiments are conducted.

Chemical treatments disinfect water by killing or inactivating pathogens. Pathogens are any disease-causing biological agent, including viruses, bacteria, parasites, and fungi. Chemicals either disintegrate pathogens (destruction) or remove their ability to cause infection (inactivation). How each chemical disinfects depends on the chemical and the pathogen being attacked. For bacteria and other microorganisms, chemicals can rupture the cell wall or diffuse through the cell wall and cause the pathogen to disintegrate from the inside out. Chemicals break up important chemical bonds, which may prevent protein production or negatively affect membrane fats. Chemicals also disrupt chemical bonds in viruses by destroying their protective shell, preventing protein production, or other methods. Factors that slow or prevent disinfection include low temperatures, high turbidity, a high concentration of chemical compounds, and sometimes pH. An effective chemical treatment reliably kills or inactivates 99.99% of pathogens.

Chemical tablets take a different amount of time to attack different pathogens. A chlorine-dioxide tablet takes 15 minutes to kill or inactivate viruses and bacteria and 30 minutes to eliminate giardia lamblia, a cyst or parasite that causes intestinal illness. To eliminate cryptosporidium parvum, another parasite, the water must sit for a full 4 hours. Note that the wait time begins after the tablet has dissolved. Five or ten minutes should be added on to the above wait times to give the tablet time to dissolve.

The most important design consideration is that the correct amount of chemical be added to a given supply of water. Adding too little chemical will not effectively neutralize disease-causing organisms. More significantly, adding too much chemical can be harmful to those who drink the water. Using chemical tablets as opposed to powders or liquids eliminates the difficulty of precise measuring. Most tablets—including the ones selected for this project—are designed to treat one liter of water. One liter of water will be achieved by filling the outlet cup to the marked one liter line of the outlet cup. Because the outlet cup is clear students can see when the tablet has dissolved so that they can start the wait time appropriately.

Chlorine-dioxide was chosen as the most effective disinfectant for cost and safety purposes. Chlorine-dioxide is a commonly used disinfectant, is effective in small doses, and is inexpensive. Other chemical disinfectants include bromine, chlorine, and iodine. Iodine is one of the more common chemicals use in water purification, but a chlorine-based treatment was chosen over iodine to avoid the risk of iodine allergic reactions. Other disinfectants are generally not as effective in small doses as chlorine-dioxide.

### EXAMPLE

Examples of tests that may be performed with the system of the present invention will now be described.

### Bacteria Test

IDEXX Colisure and E. Coli tests were performed on the different purification solutions in order to verify their effectiveness at eliminating coliform bacteria and E. Coli. A 100 mL sample of water is mixed with a Colisure reagent and then poured into a Quanti-Tray®. The Quanti-Tray® holds the water sample in 97 wells of three sizes. The trays are incubated at 34° C. for 24 hours. A computer program calculates the total number of coliforms from the number of cells that change color from yellow to purple. The maximum Most Probable Number (MPN) of coliforms per mL that can be determined from the test is 2419 MPN/mL; in this case, all the cells have turned purple, but the total MPN/mL may exceed 2419. Yellow indicates less than 1.0 MPN/mL. The presence of E. Coli is determined by shining a black light or UVA light on the Quanti-Tray®. The number of wells that fluoresce indicates the amount of E. Coli.

The chemical, FO, RO, and UV methods are all designed to eliminate the risk of coliform bacteria and E. Coli. Sediment and carbon filters were used as pre-filters for most of the tests we ran on our system. The sediment and carbon filters do not eliminate bacteria, as is shown below. All methods were tested on water collected from Braes Bayou, a highly contaminated water source in Houston, Tex. Control experiments were conducted on tap water and unfiltered Bayou water. The tap water is a control for a negative bacteria test, and the Bayou water is a control for a positive bacteria test.

As shown in the table, most of the technologies performed according to the expectations. The sediment and carbon filters, which do not remove bacteria, showed the maximum possible MPN/mL of both coliform bacteria and E. Coli. Two FO products were tested. The X-Pack, and the LifePack, eliminated all bacteria. Two UV products were also tested. The SteriPen was not as effective as anticipated. The SteriPen is designed to purify 1 L of water in 90 seconds. A half dose of 45 seconds did not eliminate the bacteria, as can be expected. However, a double dose of 180 seconds reduced the coliform bacteria by 97.8% and E. Coli by 99.8% but did not eliminate it entirely. The AquaStar was preferred over the SteriPen due to more satisfying bacteria tests. The AquaStar is designed to purify 1 L of water in 80 seconds. However, it was tested in the final housing, when the total amount of water was approximately 1.2 L. Consequently, the single dose of UV light—80 seconds—eliminated 93.9% of the bacteria, but two doses of UV light—160 seconds—eliminated 99.9%. Note that for two doses of UV light, the cell at the top of the Quanti-Tray® was yellow when the test was first run but turned purple several days later. This effect suggests that either there was a small amount of bacteria present or that somehow the test was re-contaminated. The RO membrane was also tested after a sediment and carbon pre-filter. This solution eliminated 99.9% of the coliforms, as expected. E. Coli tests were not conducted on either the new UV design or the RO design.

TABLE 1
Coliform Bacteria Test Results
All tests were conducted on Braes Bayou water
unless otherwise indicated.

| | | Total | | E. Coli | |
|---|---|---|---|---|---|
| | Pre- | Coliforms | % | (MPN/ | % |
| Sample | filters | (MPN/mL) | removal | mL) | removal |
| Tap Water | None | <1.0 | N/A | <1.0 | N/A |
| (control) | | | | | |
| Bayou Water | None | 2419 | N/A | 2419 | N/A |
| (control) | | | | | |
| Sediment | None | 2419 | 0% | 2419 | 0% |
| Carbon | None | 2419 | 0% | 2419 | 0% |
| Chemical | Sediment, | 2 | 99.9% | <1.0 | 99.9% |
| 4 hours | carbon | | | | |
| FO - X-Pack | None | <1.0 | 99.9% | <1.0 | 99.9% |
| 14 days | | | | | |
| FO - LifePack | None | <1.0 | 99.9% | <1.0 | 99.9% |
| 1 day | | | | | |
| UV - SteriPen | None | 2419 | 0% | 2419 | 0% |
| 90-second dose | | | | | |
| UV - SteriPen | Sediment, | 2419 | 0% | 248.9 | 89.7% |
| 45-second dose | carbon | | | | |
| UV - SteriPen | Sediment, | 52.9 | 97.8% | 4.1 | 99.8% |
| 180-second dose | carbon | | | | |
| UV - AquaStar | Sediment, | 146.7 | 93.9% | N/A | N/A |
| 80-second dose | carbon | | | | |
| UV - AquaStar | Sediment, | <1.0 | 99.9% | N/A | N/A |
| 160-second dose | carbon | | | | |
| RO | Sediment, | <1.0 | 99.9% | N/A | N/A |
| | carbon | | | | |

A less sophisticated presence/absence bacteria test also was conducted on several of the methods. A chemical tablet is added to a 10-mL sample of water, and like the previously described test, the resulting mixture fosters the growth of bacteria. The test is not quantitative: it merely indicates the presence or absence of bacteria. Bacteria is present if the mixture is yellow, and foam—generated during the test—floats at the surface of the water. The test is negative if the mixture is red and the foam remains at the bottom of the bottle.

This test was only conducted on one of the purification solutions, the FO X-Pack, with water that had been contaminated with dirt. The X-Pack is designed to last 10 days. A test was conducted on the purified water one day after use and six days after use (half the total life). Both tests were negative for bacteria. A control test was conducted on tap water (negative for bacteria) and a control test on water contaminated with dirt and with fecal matter (positive).

TABLE 2
Bacteria Test Results

| Sample | Presence of Bacteria |
|---|---|
| Tap Water (control) | No |
| Water with dirt | Yes |
| Water contaminated with fecal matter | Yes |
| FO - X-Pack 1 day | No |
| FO - X-Pack 6 days | No |

In addition to proving that the methods work correctly, the bacteria tests are a colorful way to illustrate theory to students. The presence/absence test is inexpensive, and can be implemented in schools around the world. Many students have experience testing water sources but now can test water before and after passing it through the different purification methods.

### Chlorine Test

The carbon filter is intended to remove some harmful chemicals. In order to test this feature, a chlorine dioxide tablet was dissolved in 1 L of tap water. A home water testing kit was used to verify the presence of chlorine in the water. This test could only rate chlorine up to 5 ppm. The chlorine dioxide tablets are designed to create a 3 ppm solution. However, the tap water already had a large chlorine concentration. Both tap water and tap water with a dissolved chlorine tablet scored above 5 ppm. However, after running the water through the carbon filter, the test kit showed that there was 0 ppm in the water. Thus, the carbon filter effectively removes chlorine from the water.

This test provides an effective demonstration for students. Students can see the color change depending on the amount of chlorine in the solution and can even participate in this simple testing process. This test helps them to understand the unseen effects of filtering chemicals out of the water.

### Forward Osmosis Dye Test

The FO system has a limited lifetime of ten days. In order to verify that the FO system is working, a caramel dye that comes with the X-Pack is added to the dirty water on the outside of the membrane. If the dye is drawn across the membrane into the bag, the FO system is no longer working effectively.

The system of the preferred embodiment of the present invention is intended for demonstrations and laboratories, which means that it will be used intermittently throughout a school year. Consequently, a test was performed to determine if the FO membrane could be dried out and reused or if it had to be kept wet at all times and then replaced after its lifetime expired. The X-Pack membrane was allowed to dry out for several days. Water was then added to the outside of the bag and dye was added to the water. After waiting for the water to pass through the membrane, it was found that the dye had also passed into the interior of the bag. Thus, the membrane cannot be allowed to dry out, and the FO must be replaced periodically. Because the caramel dye is meant for the X-Pack, this test was not reproduced with the LifePack. However, the FO membrane is the same for both systems and so should react identically to the dye.

### Food Coloring

A food coloring test was performed on the sediment and carbon filters. This test is designed to demonstrate two aspects of the filtration process. First, the carbon filter has a micron rating smaller than the sediment filter by a factor of 10. Students can see the difference between the cloudy water that comes through the sediment filter and the clearer water that passes out of the carbon filter, but adding food coloring makes the test more dramatic and easier to understand. The water is obviously colored after passing through the sediment filter and clear after the carbon filter. One thus can explain to the students that the food coloring particles are small enough to pass through one filter but not the other. Second, the food coloring can represent chemical contamination. Carbon filters remove chemical contaminants, but this process cannot be seen by the naked eye. In some experiments, dissolving a chlorine dioxide tablet in water was coupled with adding food coloring. The food coloring lets students “see” that the carbon filter removes harmful chemicals whereas the sediment filter cannot. This visual reinforces the quantitative results seen in the chlorine test that was described earlier.

A second food coloring test was conducted on the FO. In the FO process, a concentration gradient draws nothing but water across the membrane. Adding food coloring to the dirty water outside the FO bag makes it obvious that the water outside the membrane is dirty, whereas that inside the membrane is clean. This test was conducted both on the X-Pack and the Life-Pack a couple of weeks after their first use. Both FO systems worked successfully: the water on the inside of the membranes was clean despite the food coloring outside the membrane.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A portable water filtration/purification system comprising:
a plurality of filtration/purification housings, each said housing being removably connectable to each other of said plurality of housings;
a different type of water filtration/purification sub-system within each said housing; and
a pressurization cap connectable to said housings,
wherein said plurality of filtration/purification housings are removably connectable to one another in a stacking manner such that combination of said housings can be connected in various sequences and be pressurized via said pressurization cap.

2. A water filtration/purification system according to claim 1, wherein said plurality of water filtration/purification housings are color-coded.

3. A water filtration/purification system according to claim 1, wherein at least one of said plurality of water filtration/purification housings comprises threaded PVC fittings and pipe.

4. A water filtration/purification system according to claim 1, wherein said water filtration/purification subsystem within a first of said housings comprises a sediment filter.

5. A water filtration/purification system according to claim 4, wherein said water filtration/purification subsystem within a second of said housings comprises a carbon filter.

6. A water filtration/purification system according to claim 4, wherein said water filtration/purification subsystem within a second of said housings comprises a reverse osmosis filter.

7. A water filtration/purification system according to claim 4, wherein said water filtration/purification subsystem within a second of said housings comprises a forward osmosis filter.

8. A water filtration/purification system according to claim 4, wherein said water filtration/purification subsystem within a second of said housings comprises a chemical purification sub-system.

9. A water filtration/purification system according to claim 4, wherein said water filtration/purification subsystem within a second of said housing further comprises:
an ultraviolet light purification sub-system within a subsequent housing.

10. A water filtration/purification system according to claim 1, wherein said housings are stacked one on top of the other and said water filtration/purification subsystems within each said housing comprise:
a sediment filter within a first housing;
a carbon filter within a second housing subsequent in said stack to said first housing; and
a reverse osmosis filter within a third housing subsequent in said stack to said second housing.

11. A water filtration/purification system according to claim 10, wherein said water filtration/purification subsystems within each said housing further comprise:
a chemical purification sub-system within a fourth housing subsequent in said stack to said third housing.

12. A water filtration/purification system according to claim 10, wherein said water filtration/purification subsystems within each said housing further comprise:
an ultraviolet light purification sub-system within a fourth housing subsequent in said stack to said third housing.

13. A water filtration/purification system according to claim 12, wherein said plurality of water filtration/purification housings are color-coded.

14. A portable educational water filtration/purification system comprising:
a sediment water filter within a first housing;
a carbon water filter within a second housing;
a reverse osmosis water filter within a third housing;
a chemical water purifier within a fourth housing;
an ultraviolet light water purifier within a fifth housing;
wherein each of said first, second, third, and one of said fourth or fifth housings can be connected together in any sequence and/or in any sub-combination, in a substantially water-tight manner.

15. A portable educational water filtration/purification system according to claim 14, further comprising:
a forward osmosis water filter within a sixth housing.

16. A portable educational water filtration/purification system according to claim 15 further comprising:
a pressurization cap for pressurizing at least one of said first, second, third, fourth. fifth and sixth housings.

17. A portable educational water filtration/purification system according to claim 14 further comprising:
a receptacle for receiving filtered/purified water, said receptacle comprising means for stacking with said first, second, or third housings.

18. A portable educational water filtration/purification system according to claim 17, further comprising a backpack for storing said housings.
